(19) United States
(12) Patent Application Publication
(10) Pub. No.: US 2012/0023653 A1
(43) Pub. Date: Feb. 2, 2012

(54) DELAYED-RELEASE SHAPED BODIES FOR USE IN TOILETS

(75) Inventor: Rudolf Eduard Nijburg, Gorinchem (NL)

(73) Assignee: PURAC BIOCHEM BV, Gorinchem (NL)

(21) Appl. No.: 13/202,902

(22) PCT Filed: Feb. 24, 2010
(86) PCT No.: PCT/EP2010/052315

§ 371 Date: Oct. 18, 2011

Related U.S. Application Data
(60) Provisional application No. 61/202,420, filed on Feb. 26, 2009.

(30) Foreign Application Priority Data
Feb. 26, 2009 (EP) 09153787.8

(51) Int. Cl. E03D 3/00; A01P 1/00; A01N 37/36

(52) U.S. Cl. 4/300; 424/78.38; 514/547

(57) ABSTRACT

A shaped body suitable for use as acid-releasing body in toilets includes 10-95% of a lactic acid oligomer with an average degree of polymerization between 1.8 and 4. The shaped body provides for the controlled release of lactic acid, which serves to reduce or prevent to the formation of calcium and magnesium deposits in the toilet, contributes to soap scum removal, and has a sanitizing and disinfecting effect. The shaped bodies may be used in-bowl or in-cistern.

### CROSS-REFERENCE TO RELATED APPLICATION

This Application is a Section 371 National Stage Application of International Application No. PCT/EP2010/052315, filed Feb. 24, 2010 and published as WO 2010/097398 A1 on Sep. 2, 2010, in English, which in turn is based on and claims benefit of U.S. Provisional Application No. 61/202,420, filed Feb. 26, 2009.

### BACKGROUND

The discussion below is merely provided for general background information and is not intended to be used as an aid in determining the scope of the claimed subject matter.

An aspect of the present invention pertains to shaped bodies suitable for use in toilets which show a delayed release of a cleaning composition. Within this sector, two embodiments may be distinguished, namely shaped bodies that are applied in as in-cistern agents, and shaped bodies that are applied as in-bowl agents.

In both cases, the shaped body should show a delayed release of a cleaning composition. Commercial tablets for use as in-bowl agents often generate a neutral to alkaline environment. Their main action is to remove or prevent the formation of scale via sequestering/chelating of mineral deposits. This is often accompanied by the use of environmentally unfriendly sequestering agents such as EDTA and phosphates.

Commercial liquid cleaning formulations are typically acidic in nature, to remove scale, soapscum, and bacteria. It is believed that acidic compositions show a higher effectiveness in toilet bowl cleaning than alkaline compositions.

Accordingly, there is a need in the art for a shaped body, suitable for use as in-bowl or in-cistern release agent which provides a controlled release of acid under the conditions in which it is used.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

An aspect of the present invention pertains to a shaped body suitable for use as acid-releasing body in toilets, which comprises 10-95% of a lactic acid oligomer with an average degree of polymerization between 1.8 and 4. It has been found that the use of a lactic acid oligomer with a degree of polymerization in this range provides the release of lactic acid at a speed and a concentration which is active against the formation of calcium and magnesium deposits in toilet bowls.

The use of a lactic acid oligomer has been found to have a number of further advantages. One advantage is that lactic acid is produced by fermentation, and therewith qualifies as a renewable material. Further, the solubility of fragrances in lactic acid oligomers is better than the solubility of fragrances in an hydroxyacetic acid-lactic acid polymer. As the provision of fragrances is one of the main functions of a shaped body, be it an in-bowl or an in-cistern body, this is an important advantage of the present composition.

In the composition described herein, the lactic acid oligomer is water-insoluble and is biodegradable. The oligomer is a polyester which reacts with water, i.e., the water attacks the ester bond to give carboxylic acid and alcohol, thus ensuring the controlled release of lactic acid. Lactic acid is soluble in water, and its presence reduces or prevents the formation of calcium and magnesium deposits in the toilet. Further, lactic acid has a sanitizing and disinfecting effect due to its antibacterial activity. It also contributes to soap scum removal.

Aspects of the invention will be described in more detail below.

### BRIEF DESCRIPTION OF THE DRAWINGS

FIG. 1 is a graph of the pH of water over time for five different compositions of a in-bowl shaped body as described herein.

FIG. 2 is a graph of the pH of water over time for a commercially available in-bowl toilet block.

FIG. 3 is a graph of the pH of water over time for five different compositions of an in-cistern shaped body as described herein.

FIG. 4 is a graph of the pH of water over time for a commercially available in-cistern toilet block.

### DETAILED DESCRIPTION

The shaped body according to an aspect of the invention contains 10-95 wt. % of a lactic acid oligomer with an average degree of polymerization between 1.8 and 4. The amount of lactic acid oligomer is determined by cost considerations and activity considerations. In general, the amount of lactic acid oligomer in the shaped body according to the invention is in the range of 5 to 50 grams. For in-cistern bodies a more specific range may be given of 12 to 50 grams, more in particular of 24 to 50 grams. For in-bowl bodies, a more specific range may be given of 5 to 35 grams, more in particular of 10 to 32 grams.

Selection of the amount of lactic acid oligomer within this range ensures that the shaped body has an adequate lifetime, e.g., a life-time in the range of one week to 20 weeks, in particular in the range of 2 weeks to 10 weeks. The life-time of the shaped body is defined as the time between the provision of the body in the toilet and the moment that the body has completely dissolved.

The shaped body according to an aspect of the invention comprises 10-95 wt. % of lactic acid oligomer. For in-cistern bodies a more specific range may be given of 25-95 wt. %, more in particular of 50-95 wt. %. For in-bowl bodies, a more specific range may be given of 10-70 wt. %, more in particular of 20-65 wt. %. In one embodiment, the shaped body comprises at least 20 wt. % of lactic acid oligomer, in particular at least 30 wt. % of lactic acid oligomer.

The shaped bodies described herein each generally have a weight of from 15 to 100 grams, preferably from 15 to 70 grams, more preferably from 20 to about 65 grams.

The shaped body comprises a lactic acid oligomer with an average degree of polymerization between 1.8 and 4. The wording lactic acid oligomer encompasses both straight-chain and cyclic lactic acid oligomers. In a particular embodiment of the present invention the lactic acid oligomer is for at least 50 wt. % made up of lactide, which is a cyclic lactic acid oligomer. More in particular, the lactic acid oligomer is for at least 70 wt. % made up of lactide, still more in particular for at least 80%, even more in particular for at least 90%. The advantage of using lactide is that it is a solid at room temperature, is easy to shape, and has good dissolution properties.

The shaped body may comprise various additional components.

In one embodiment the shaped body comprises one or more fragrances. The term fragrance is intended to refer to any compound which gives of an appropriate odor, generally of freshness, when the toilet is flushed. The fragrance may be in solid form or liquid form and is suitably present in an amount of 0.1 to 7 wt. %, more in particular in an amount of 0.5 to 4 wt. %.

Copolymers of lactic acid and hydroxyacetic acid with a molecular weight of 800-4000 are believed not to contribute to obtaining the effects associated with aspects of the present invention, their presence in the tablets is not required. Accordingly, in one embodiment, the shaped body contains less than 10 wt. %, more in particular less than 5 wt. %, even more in particular less than 2 wt. % of said compound.

If so desired, the shaped body may also comprise fillers, which do not provide additional cleaning activity to the shaped body.

Filler materials may be used in the compositions so that it can be formed into solid objects of desired sizes, shapes and designs without using excessive amounts of active ingredients.

Fillers may be used in an amount of, for example, 5-90 wt. %, more in particular 10-50 wt. %. The amount of filler will depend on the desired weight of the final block and on the desired amount of active component.

Preferably, the filler is water-soluble, to allow complete dissolution of the shaped body according to the invention. Suitable fillers include water-soluble inert salts such as sodium chloride, sodium or calcium sulfate, sodium or calcium carbonate, starch, etc.

The composition may also contain a dye, to impart color to the water when the toilet is flushed. Suitable dyes are released from the shaped object when the toilet is flushed. The dye, if present, may be used in a concentration of, generally, from 0.01 to 5 wt. %. For in-cistern bodies, a general range of 1 to 5 wt. %. may be mentioned. For in-bowl bodies, a general range of 0.01 to 0.5 wt. % may be mentioned. Suitable dyes are known in the art. Examples of suitable dyes are Acid Blue No. 9, Carta Blue V (C.I.24401), Acid Green 2G (C.I.42085), Astragon Green D (C.I.42040), Maxilon Blue 3RL (C.I. Basic Blue 80), Drimarine Blue Z-RL (C.I.Reactive Blue 18), other Acid Blue 9 type dyes, and Sanolin-Blau EHRL, material No. 154640 of Clariant.

If so desired, the composition may comprise a surfactant, in particular a non-ionic surfactant, or a quaternary surfactant with a low water content. The use of an anionic surfactant is less preferred. If so desired, the composition may also contain additional components like oxidizing agents, chelants, algicides, quaternary ammonium salt, and bleaching agents like (solid) peroxides, such as sodium percarbonate or perborate. It is within the scope of the skilled person to select appropriate further components for the shaped body.

The shaped bodies may be manufactured by a process comprising the steps of melting the lactic acid oligomer, blending in other components, and allowing the composition to solidify, wherein the composition is subjected to a shaping step to form shaped bodies before the solidification step, e.g., by pouring it in a mold, or after the solidification step, e.g., by cutting shaped bodies of appropriate size and shape from a solidified block or plate. The bodies may also be shaped using an extrusion process.

In one embodiment, the molten composition is cast into polymer molds, or molds coated with a polymer foil wherein the polymer mold or foil is subsequently used in the packaging of the product. In this case, it is preferred for the foil to be impermeable for water under storage conditions of the shaped bodies.

The shaped body may have any desirable shape, e.g., rectangular (block), in the shape of pucks, stars, balls, shells, cylinders or any other suitable shape. The shape of the product, more in particular its surface to volume ratio is of influence on the dissolution rate of the body. It is within the scope of the skilled person to optimize the shape of the body.

The in-bowl bodies will in use generally be affixed to the rim of the toilet bowl using a removable holder. The in-cistern bodies may be placed in the cistern of the toilet, e.g., on the bottom, or connected by some means to the edge of the cistern.

The shaped bodies are suitable for use as in-cistern or in-bowl agents to effect the delayed release of lactic acid. Accordingly, an aspect of the present invention also pertains to the use of these compositions in these applications. An aspect of the present invention also pertains to a process for ensuring a delayed release of lactic acid in a toilet, wherein a shaped body is placed in a cistern or a bowl of a toilet connected to a means for providing flush water and a means for removing waste water. An aspect of the invention also pertains to a toilet connected to a means for providing flush water and a means for removing waste water, wherein a shaped body is present in the cistern or the bowl of the toilet.

Aspects of the present invention are elucidated by the following examples, without being limited thereto or thereby.

### EXAMPLE 1

### Preparation and Testing of In-Bowl Shaped Bodies

In bowl-shaped bodies A through E were manufactured with the composition given in table 1.

TABLE 1
composition of tested formulations:

| | Formulations, in wt. % | | | | |
|---|---|---|---|---|---|
| Ingredients % | A | B | C | D | E |
| Lactide (PURAC) | 45 | 70 | 30 | 45 | 50 |
| Polyethylene glycol mw. 8000 | 35 | 10 | 50 | — | 35 |
| Polyethylene glycol mw. 4000 | — | — | — | 35 | — |
| C15/14-oxo-alcohol-EO8 | 7 | 7 | 7 | 7 | 7 |
| Coco-amide monoethanolamide | 10 | 10 | 10 | 10 | — |
| Geraniol (fragrance) | — | — | — | 3 | 2 |
| Citral (fragrance) | 3 | 3 | 3 | — | 2 |
| Laureth-3 | — | — | — | — | 2 |
| Laureth-7 | — | — | — | — | 2 |
| Dye* | q.s. | q.s | q.s. | q.s. | q.s. |

*several color (combinations) could be used

The shaped bodies A through E were manufactured as follows: The ingredients except for the dye and the fragrances were combined and the mixture was heated until a homogenous liquid mixture was obtained. Then, the dye and the fragrances were added and mixed through the mixture. The hot transparent and homogenous liquid mixture was poured into a cylinder-shaped mold, with a diameter of ±2.5 cm, and cooled down to room temperature. The obtained rigid blocks had a weight of about 10 grams, a diameter of about 2.5 cm, and a height of about 2.5 cm. All prepared formulations have a typical melting point of above 60° C.

The compositions A through E were tested as follows. As a reference, a commercially available in-bowl toilet block with a weight of 48 grams was also tested (WC Eend Origineel Blauw toiletblok, Bolton Nederland BV).

pH-Development in Demineralised Water (Demi) at Room Temperature

500 mL glass beakers (high model) were filled with 500 ml water. In each glass a block was placed on a holding device which made it possible to stir the solution without stirring the block. The water was stirred at a constant stirring speed of ±500 rpm. The pH of the solutions was monitored, until the toilet block was completely dissolved or a stable pH was reached.

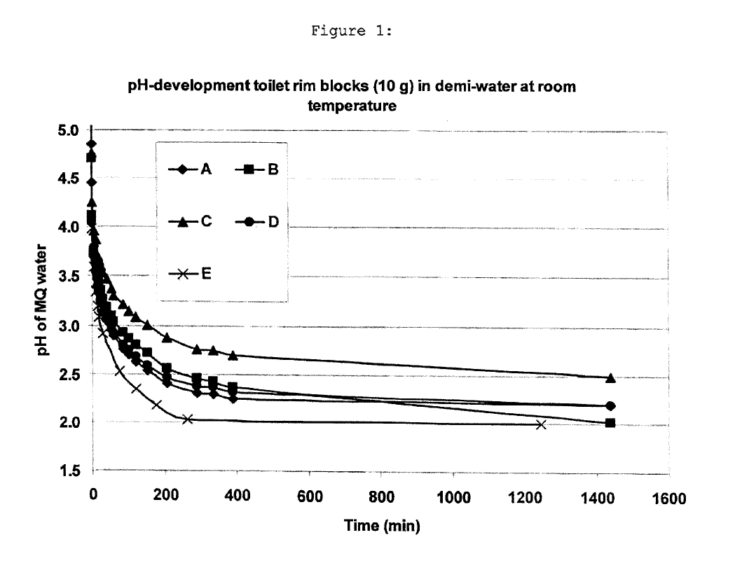

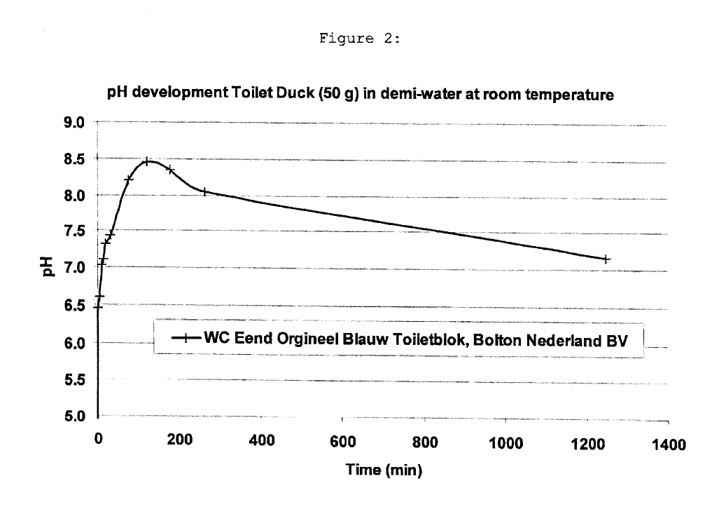

The results are presented in FIGS. 1 and 2. FIG. 1 shows that the shaped bodies show a continuous acid release. When higher concentrations of lactide are used, more acid is released in time, which result a lower pH. As appears from FIG. 2, the commercial toilet block does not show an acid release. In contrast, it shows a pH-increase.

Dissolution Time

Observation during the experiment shows that all tested compositions A through E had a dissolution time which is at least as long as the dissolution time of the commercial composition. The commercial block dissolved in about 3 hours. The blocks dissolved in a period of 6.5 to 19 hours and above. It is noted that in these experiments the dissolution speed of the blocks is higher than in commercial operation, due to the application of stirring and the fact that the blocks are immersed in water.

Flush Water Experiment

In order to check the acid release under flushing conditions, the following experiment was performed.

A shaped body was prepared with the composition of Formulation E in table 1 above. It was shaped using an aluminum cylindrical mold having a length of 10 cm and a diameter of 2.5 cm. The weight of the block was 38-40 g. After cooling down to room temperature, the obtained rigid toilet block was placed in a commercial toilet rim block holder, which was placed under a funnel. 600 milliliters of water was poured into the funnel in portions. The last droplets of water flush were collected in order to measure the pH. Also the pH of the water was measured before the flush. Two experiments were carried-out, one with demi-water, and one with tap water of Gorinchem, the Netherlands, having a water hardness of 13° dH.

The results of this experiment are shown in table 2 and clearly indicate that acid is being released.

TABLE 2
pH of flush water after contact with toilet block

| pH flush | | After 1^{st} | After 2^{nd} |
|---|---|---|---|
| water: | Before flush | flush | flush |
| Demi-water | 5.66 | 3.62 | 2.85 |
| Tap water* | 8.18 | 2.64 | 2.58 |

### EXAMPLE 2

### Preparation and Testing of In-Cistern Shaped Bodies

In-cistern shaped bodies A through E were manufactured with the composition given in table 3.

TABLE 3
composition of tested formulations:

| | Formulation | | | | |
|---|---|---|---|---|---|
| Ingredients % | A | B | C | D | E |
| Lactide | 90 | 85 | 90 | 85 | 85 |
| Polyethylene glycol mw. 8000 | 5 | 10 | — | — | 5 |
| Cocoamide monoethanolamide | 2 | 2 | 2 | 2 | 2 |
| Fragrance | 3 | 3 | 3 | 3 | 3 |
| Laureth-7 | — | — | 5 | 10 | 5 |
| Dye* | q.s. | q.s | q.s. | q.s. | q.s. |

*Several colors (combinations) could be used

The formulations were manufactured in accordance with the method described in Example 1. Of each formulation 10 g was taken for pH-release experiments. Shapes and dimensions of these blocks were similar to those described in Example 1.

The compositions A through E were tested as follows. As a reference, a commercially available in-cistern toilet block was also tested (WC Eend Stortbakblok, Bolton Nederland BV).

pH-Development in Demineralised Water (Demi) at Room Temperature

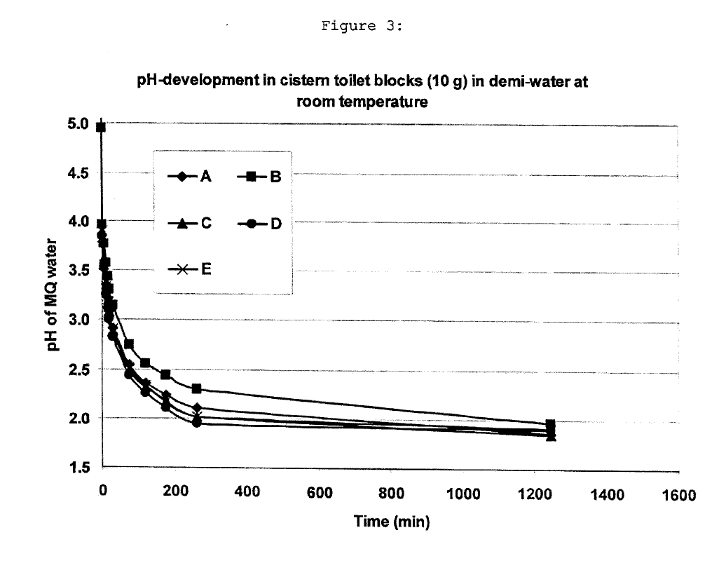

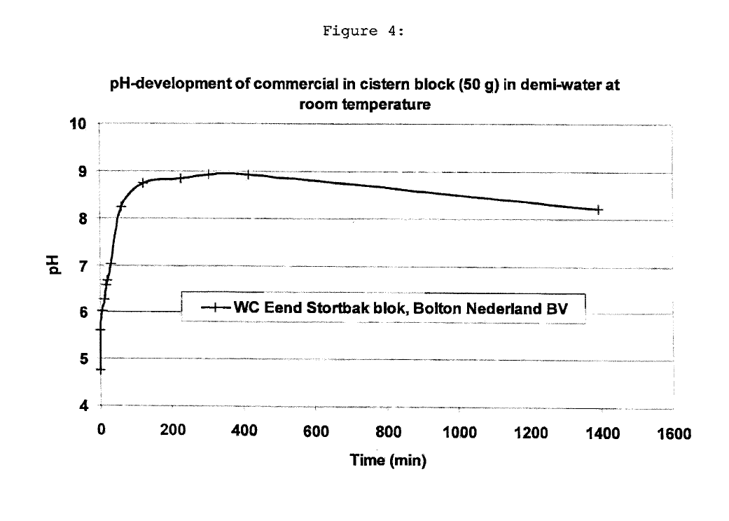

The pH development test was carried out in the same manner as described in Example 1 above. The results are presented in FIGS. 3 and 4. FIG. 3 shows that the shaped bodies show a continuous acid release. The commercial toilet block does not show an acid release. In contrast, it shows a pH-increase.

1. A shaped body suitable for use as acid-releasing body in toilets, the shaped body comprising 10-95% of a lactic acid oligomer with an average degree of polymerization between 1.8 and 4.

2. The shaped body according to claim 1 wherein the lactic acid oligomer is in an amount of 5 grams to 50 grams.

3. The shaped body according to claim 1, wherein the shaped body has a weight of from 15 to 100 grams.

4. The shaped body according to claim 1 wherein the shaped body comprises at least 20 wt. % of lactic acid oligomer.

5. The shaped body according to claim 1 wherein the lactic acid oligomer is for at least 50 wt. % made up of lactide.

6. A process for manufacturing the shaped body according to claim 1, comprising the steps of melting the lactic acid oligomer, and allowing the composition to solidify, wherein the composition is subjected to a shaping step to form shaped bodies before the solidification step or after the solidification step.

7. A use of the shaped body according to claim 1 as in-cistern or in-bowl agents in a toilet to effect the delayed release of lactic acid.

8. A process for ensuring a delayed release of lactic acid in a toilet, wherein a shaped body according to claim 1 is placed in a cistern or a bowl of a toilet connected to a means for providing flush water and a means for removing waste water.

9. In combination with a toilet connected to a source of flush water and a passage for removing waste water, a shaped body according to claim 1 is positioned in a cistern or a bowl of the toilet.

10. The process of claim 6 and further comprising blending in another component with the lactic acid oligomer.
